(19) United States
(12) Patent Application Publication
(10) Pub. No.: US 2009/0043435 A1
(43) Pub. Date: Feb. 12, 2009

(54) METHODS AND SYSTEMS FOR MAKING A GPS SIGNAL VITAL

(75) Inventors: Mark Edward Kane, Orange Park, FL (US); Harrison Thomas Hickenlooper, Palatka, FL (US)

Correspondence Address: DLA PIPER LLP (US);ATTN: PATENT GROUP, 500 8th Street, NW, WASHINGTON, DC, 20004-2131, US

(73) Assignee: QUANTUM ENGINEERING, INC., Orange Park, FL (US)

(21) Appl. No.: 11/835,050

(22) Filed: Aug. 7, 2007

(51) Int. Cl. G01C 21/20; G01S 5/14; G06F 17/00

(52) U.S. Cl. 701/19; 342/357.03; 701/215

(57) ABSTRACT

Position reports from GPS receivers can be made vital through a variety of techniques including relative differential GPS corrections and a technique in which a train traveling on a fixed path is provided with a database that includes positions on fixed paths or data from which positions on fixed paths can be determined. Position reports from GPS receivers located on the vehicle are compared to the positions of the fixed paths in the database. If the distance from the position reported by the GPS receiver to the nearest point on the nearest fixed path is greater than the stated accuracy of the GPS receiver, the position report is discarded or other corrective action is taken. A second technique involves cross-checking position reports from two GPS receivers separated by a known distance, preferably mounted on a single vehicle. Still other techniques may be used.

### BACKGROUND

The use of global positioning system (GPS) receivers on trains has been proposed for a variety of train control and safety systems. For example, U.S. Pat. No. 6,081,769 to Curtis discloses using GPS receivers mounted at the front and rear of a train to determine a length of a train. U.S. Pat. No. 6,459,965 to Polivka discloses a system in which GPS receivers are included on each train and position reports are sent from the train to wayside devices so that appropriate wayside signals can be generated in order to avoid collisions between trains. The assignee of the present application is the owner of several co-pending U.S. patent applications and issued U.S. patents involving the use of GPS receivers on trains, including U.S. Pat. No. 7,024,289 (directed toward using GPS receivers mounted on the front and rear of trains to detect train separation) and U.S. patent application Ser. No. 10/938,820 (directed toward a method for determining a train's position on a train track with a GPS receiver to a greater accuracy than the accuracy of the GPS receiver). The contents of all of the foregoing are hereby incorporated herein by reference.

For train control systems that rely on GPS as the primary means of position determination, characterization of the magnitude of the GPS position error is critical. If the position of a train is not reliably known, then any attempted control of the train with respect to speed or limits of authority is equally unreliable. The magnitude of the error must be known and accounted for in all positional operations. This characterization of the error becomes the basis of a first-order safety factor or safety distance.

New regulations for train control systems now mandate that new systems shall meet or exceed the IEEE 1483 standard for fail-safe or vital operation. While the 1483 standard specifies documentation and verification methods, other published standards specify acceptable probabilities of error (or hazard occurrences) given the frequency or probability of said occurrence. With respect to hazard determination, it can be said that a system is “vital” if the probability of a hazard is greater than six sigma. The probability of a single occurrence existing outside the range of −6 to +6 sigma is: 6.076 E-9. Said another way, the odds are 1 in 164,600,000 that the occurrence exists. This probability is sufficiently low to meet the definition of “vital.” It should be noted that for any system which is deemed fail-safe, all unique inputs into the system (that are not diversely checked) must also meet the same statistical confidence as the overall system.

Other systems may use differential GPS and GPS position over-sampling and data averaging in an effort to determine the true mean value of the position of the receiver. This may also be an effort to obtain vitality statistically from a GPS receiver that is not vital with respect to hardware, software, or communication protocols.

One problem with trying to determine the statistical confidence of GPS systems and the reported GPS positions is the fact that successive position messages are not statistically independent and therefore cannot be used as fully independent samples in any statistical analysis. This is due to the fact that the algorithms employed within the GPS receivers typically use Kalman filters and other analog and digital signal processing techniques which have an internal signal history or ‘wind-up’ as the basis for the mathematics. This means that the mathematics within GPS systems contain a history or phase lag which uses trends and historic data in the generation of the present solution. Therefore, the individual solutions are interrelated and are not statistically independent and may not be treated as such with respect to error or confidence analysis.

The exact time delay or phase lag inherent in the system, and the magnitudes thereof, are difficult to assess, but exist nevertheless. Rigorous quantification of the time delay or phase lag is possible, but requires analysis of the computational techniques within the receiver and analysis of the circuitry as applicable.

### SUMMARY

The aforementioned vulnerabilities inherent in a typical GPS system are removed by providing a means of validating the GPS performance and differential corrections by direct measurement. Using this technique, the apparent error can then be transmitted to client systems along with the applicable corrections in some embodiments. In one embodiment, a GPS receiver at a fixed location is used as a differential GPS base station. The differential GPS base station receives data from all available satellites, checks the health of individual satellites, and determines individual corrections by comparing the position data derived from the satellites to the known fixed location. The differential GPS base station then generates correction messages that inform other GPS receivers as to the corrections needed for specific satellites. In some embodiments, a second fixed GPS receiver (preferably a different make and model), which is referred to herein as a “validating receiver”, validates the corrections generated by the first receiver before said corrections are transmitted to mobile GPS systems. The corrections are validated by applying said corrections to the position generated by the fixed second receiver and then comparing the reported position of the second receiver to the known position of the fixed second receiver.

Preferably, data communications between the GPS receivers at the fixed locations, as well as communications of the correction data to the GPS receivers onboard the trains, should employ a CRC-32 or equivalent method to protect against data being corrupted during transmission. Such methods can, when used appropriately, provide a six sigma confidence that any corruption of the data will be detected. All communications involving data of a vital nature are preferably performed using CRC-32 or equivalent methods to maintain the desired statistical confidence in data and guard against corruption.

In another embodiment, a train or other vehicle traveling on a fixed path is provided with a database that includes fixed paths or data from which fixed paths can be determined. Position reports from GPS receivers located on the vehicle are compared to the vectors of the fixed paths in the database. If the distance from the position reported by the GPS receiver orthogonal to the nearest point on the fixed path vector is greater than the stated accuracy of the GPS receiver, the position report is discarded or other corrective action is taken.

In still another embodiment, two GPS receivers are mounted on a moving vehicle at a known distance apart from each other. When the vehicle is a train, the receiver may be mounted on different vehicles or on the same vehicle. Preferably, the GPS receivers and their chipsets are manufactured by two different manufacturers in order to provide diversity. In embodiments employing differential base stations, one of the GPS receivers onboard the train is preferably the same make and model as one of the GPS receivers (preferably the Validating GPS receiver) used in the differential base station. The distance between position reports from the two mobile receivers can be determined and compared to the known distance between the two mobile receivers. The difference is then compared to an allowable uncertainty. In some embodiments an additional check may be performed which requires the vehicle to be located on a fixed path, which then allows the direction of travel indicated by fixed path vector to be cross checked with the direction of travel indicated by the vehicle orientation. The vehicle orientation is determined by the reported positions of the dual mobile GPS receivers. In other embodiments in which the GPS receivers provide a direction of travel while moving, the direction of travel indicated by each of the receivers can be compared and cross-checked. If the vehicle is traveling on a fixed path, then the direction of travel indicated by mobile receivers may be cross-checked with the fixed path. In such embodiments, the GPS receivers are preferably mounted as far apart as possible (e.g., on opposite ends of a car when both receivers are installed on a single locomotive or other car). In yet another check, the speed indicated by the GPS receivers can be compared and cross-checked with the speed indicated by a separate speed measuring device, such as an axle drive speedometer on a train or the voltage across a DC traction motor or the frequency driving an AC traction motor in a locomotive.

In still other embodiments, particularly applicable to embodiments in which a vehicle travels on a fixed path, a device at a known location alongside the fixed path is used to correlate a position reported by a GPS receiver. The device has a sensor that will detect the time at which the vehicle passes the device and transmit that information back to the vehicle. In some embodiments, especially those in which the devices are not permanently located at a particular position, the device also transmits its position. In other embodiments, the vehicle has a database that includes the locations of the devices so that it is not necessary for the device to transmit its location. In such embodiments, the device may transmit an identification code so that the device is unambiguously identifiable and the corresponding device location can be retrieved from the database. Alternatively, each device may be assigned its own frequency, or the devices may be separated by sufficient distances such that only one device can be within communication range of the vehicle at any one time.

The time at which the vehicle passes the device can be used to determine the position reported by the GPS receiver at the same time. If there is no position report that corresponds to the exact time at which the vehicle passes the device, the difference in time between a contemporaneous position report from the GPS receiver and the time reported by the device along with the velocity (and, in some embodiments, acceleration) of the vehicle are used to synchronize the GPS position report to the message from the device so that the distance between the synchronized GPS position report is compared to the known position of the device. The difference between these two positions is then compared to the stated accuracy of the GPS receiver. Preferably, the device in such embodiments is a transponder. In other embodiments, the device is a wheel detector such as a hot bearing detector used in connection with railroads. In such embodiments, the device transmits the times at which the first and last wheels were detected along with the total number of wheels that were detected. This data can be used to verify that no cars on the train have become detached.

In yet another embodiment, a receiver or transceiver for digital communications, such as a receiver configured to conduct communications pursuant to the 802.11 standard, is configured to measure the change in carrier phase or the subcarrier bit timing caused by relative movement between the receiver and a point such as a transmitter or transceiver located at a train station. By measuring the direction of the shifts, the receiver can determine when direction changes, signifying the passing of the point. By measuring the magnitude of the shifts, the relative velocity can be determined. The passing of the point and/or the relative velocity can then be compared to position and/or speed information from the GPS receiver to verify that the latter is correct (i.e., operating within its specified accuracy).

### BRIEF DESCRIPTION OF THE DRAWINGS

The aforementioned advantages and features of the present invention will be more readily understood with reference to the following detailed description and the accompanying drawings in which:

FIG. 1 is a block diagram of a train control system according to one embodiment of the invention.

FIG. 2 is a flowchart of a technique for detecting an error in a position reported by a GPS receiver according to one embodiment.

FIG. 3 is a flowchart of a technique for detecting an error in a position reported by a GPS receiver according to a second embodiment.

FIG. 4 is a flowchart of a technique for detecting an error in a position reported by a GPS receiver according to a third embodiment.

FIG. 5 is a flowchart of a technique for detecting an error in a position reported by a GPS receiver according to a fourth embodiment.

FIG. 6 is a flowchart of a technique for detecting an error in a position reported by a GPS receiver according to a fifth embodiment.

FIG. 7 is a flowchart of a technique for detecting an error in a position reported by a GPS receiver according to a sixth embodiment.

FIG. 8 is a flowchart of a technique for detecting an error in a position reported by a GPS receiver according to a seventh embodiment.

FIG. 9 is a plot of a normalized Gaussian error distribution.

FIG. 10 is a logarithmic plot of the Gaussian error distribution of FIG. 9.

### DETAILED DESCRIPTION

In the following detailed description, a plurality of specific details, such as accuracies of GPS receivers, are set forth in order to provide a thorough understanding of the embodiments discussed below. The details discussed in connection with these embodiments should not be understood to limit the present invention. Furthermore, for ease of understanding, certain method steps are delineated as separate steps; however, these steps should not be construed as necessarily distinct nor order dependent in their performance.

The present invention is believed to be particularly well suited for use in the railroad industry and hence will be discussed primarily in that context herein. The present invention should not be understood to be so limited.

In the GPS system, there are three basic terms which describe the behavior and data within the system. They are generally described as accuracy/repeatability/availability. Accuracy and repeatability are typically expressed as a distance while availability is typically expressed as probability or as a percentage with respect to time. The term availability is related to the number of satellite vehicles in service, the mask angle, and the changing nature of the geometry of the GPS satellite constellation. This is expressed in the HDOP or PDOP variability. As an example, standard GPS accuracy/availability is typically specified as a one sigma error of 8 meters (95% of the time). This means that the position information from standard GPS will be within 8 meters of the true position at least 95% of the time.

For a system which exhibits a normal distribution of errors the term accuracy refers to the absolute error that the reported value exhibits from the true value. The errors follow the distribution.

Repeatability or precision refers to the behavior where a system will reliably repeat the same data even though the data has an existing error. The error is typically repeated. Such a system could be termed ‘repeatable’ by not necessarily accurate.

For GPS, the errors in the position fixes follow a normal distribution. Under such a distribution, for any given data point, the probability of the occurrence of an error can be calculated given the magnitude of the error (‘r’).

The formula is:

$$Err ( r ) \text{:} = \frac{1}{\sqrt{2 \cdot π}} \cdot {e}^{- [ \frac{{( \frac{r}{σ} )}^{2}}{2} ]}$$

GPS has further accuracy degradations due to the geometry of the satellite constellation and the geometry (locations) of the satellites it is able to track. If a train wishes to know its location on a track, then a satellite perpendicular to the track is of little or no use. This is because the mobile GPS device can only measure the receiver's distance from the satellite. On the other hand, if a satellite is collinear with the track, then the distance from that satellite provides the best possible data with respect to the ‘milepost.’

Trains are normally shielded (satellites are hidden from view) by bluffs or the sides of hills. This is a natural consequence of the track being built on a semi-level path. Fortunately the paths tend to have few sharp bends. This generally provides a good “view,” or unobstructed line-of-sight path, along the principal axis of interest (the axis that is collinear with the track).

The term for the constellation geometric uncertainty is “dilution of precision” or DOP. The DOP can be reported in a number of ways. HDOP is the horizontal only (2-D), and PDOP is the position dilution of precision (3-D). The GPS satellite constellation almost always has much greater uncertainty in the vertical direction for the same reasons noted earlier about milepost uncertainty. At any given time there are usually very few satellites at a high angular altitude (far above the horizon), relative to a GPS receiver.

Using the HDOP provides the data of the greatest interest for railroad navigation, the apparent errors in the latitude and longitude. From the error equation (1) above, HDOP can be accounted for by a simple modification:

$$Err ( r , h ) \text{:} = \frac{1}{\sqrt{2 \cdot π}} \cdot {e}^{- [ \frac{{( \frac{r}{h \cdot σ} )}^{2}}{2} ]}$$

Where the term ‘h’ is the HDOP value, which is calculated using the geometric positions of the satellites used in the solution.

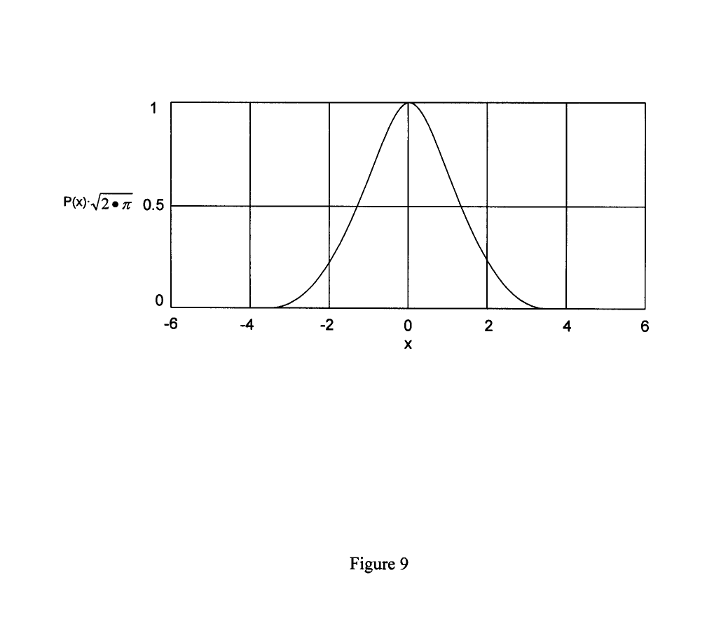

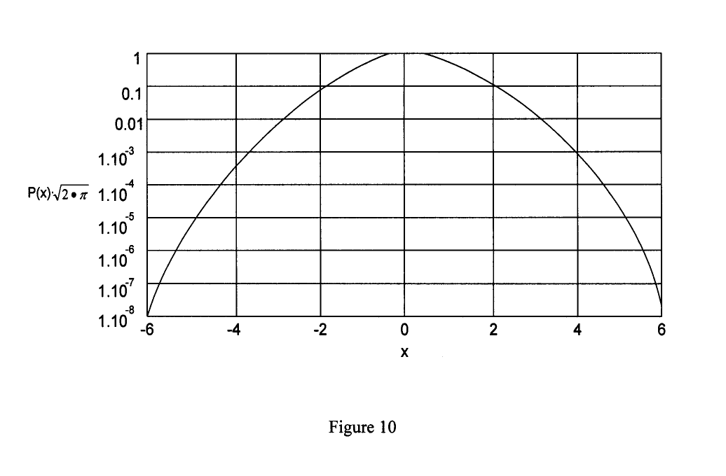

A normalized error distribution takes the form of the plot illustrated in FIG. 9, where ‘x’ is the standard deviation. The error distribution is plotted in a logarithmic fashion in FIG. 10. From FIG. 10 it can be seen that at six sigma (x is equal to 6), the probability of an occurrence happening outside of the confines of the curve is quite low.

To increase the statistical confidence in the positions generated by a GPS system, one technique is to expand the error range to an extent that the probability of a data point outside the error “window” is six sigma or higher. Since GPS is defining a point, the error “window” can best be described as an error “radius” since the error is normally reported as circular. This can be calculated using a standard, non-differential, single-receiver GPS system. Whereas the one sigma error in standard GPS is in the range of 8 meters, a six sigma error is on the order of 48 meters. This is with an HDOP of 1.0 which is an optimum, and seldom seen, condition.

In addition to the position fix errors discussed above, there are other sources of errors in GPS receivers. These include foliage, moisture (typically on foliage), weather, multi-path, and others.

Whereas in simple computer systems it may be trivial to build a dedicated single function that is deemed vital, it is quite different for most mechanical systems such as the braking system in a train. The more complex the system, the more difficult it is to obtain or prove vital operation. Because of the complexity and time involved, the design of a vital system is typically a dedicated task reserved for specific applications or processes.

The same is true of the majority of GPS receivers. Most commercial GPS systems are not designed to be vital. To begin with, the communication protocols employed by commercial GPS receivers are not vital with respect to the statistical confidence of a single message. This includes the NEMA protocol.

Different GPS manufacturers typically use the NEMA protocol as well as different proprietary serial communication protocols. These serial communication protocols use different methods to verify the integrity of the communicated data. Methods can range from 8 bit checksums to 16 bit CRCs (cyclical redundancy codes). Statistically, the checksum is a very poor method of detecting a data error, and neither the checksum, nor CRC16, approaches the six sigma statistical level of certainty that is required to be vital. Thus, GPS receivers cannot be made failsafe or vital by only assigning a large error radius to a single data communication. Therefore at a minimum, a multiplicity of communications is required.

Also, the internal calculations and processes within the GPS receivers generally do not meet the aforementioned vitality standards. Internal data may not be protected from corruption, and the processors and processes may not be vital. This is due to the fact that a typical commercial GPS receiver was never designed and manufactured with fail-safe or vital navigation in mind. If it was, then the manufacturer would generally select a far more robust communications protocol than what is commonly found within the industry.

Also, as mentioned previously, multiple position fixes from one receiver cannot be treated as wholly separate, statistically unique, position fixes or samples due to pipelining effects in the internal mathematics. This means that the GPS receivers tend to be repeatable, even with an existing error.

Another noteworthy issue is that the statistical confidence in checksums and CRCs depends upon the size of the data that the checksum or CRC is supposed to protect. The greater the data size within the encapsulation, the lower the confidence that a single or multiple bit error can be reliably detected.

The embodiments discussed below address the issues discussed above. The motivation behind these embodiments is to increase the confidence of the position solutions, or at a minimum, characterize the errors generated by GPS receivers.

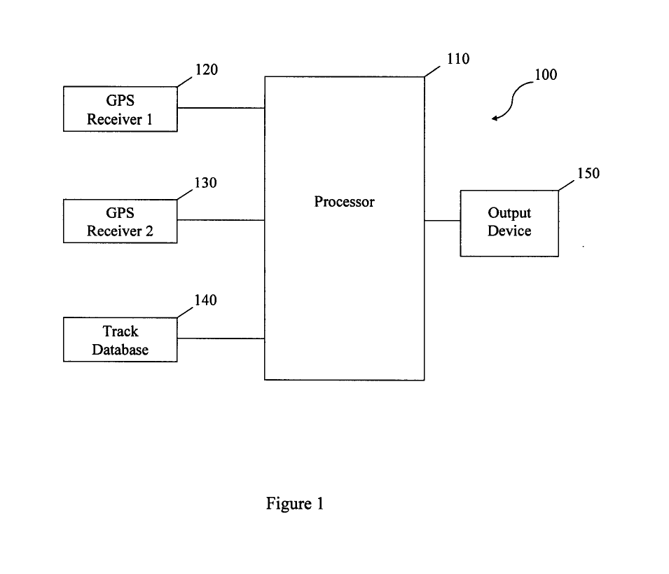

Referring now to FIG. 1, a system 100 according to one embodiment includes a processor 110 connected to a first GPS receiver 120 and a second GPS receiver 130. In some embodiments, the processor 110 is a part of a train control system (or is in communication with a train control system) and a result of the techniques discussed below is used by the train control system for the purpose of controlling movement of the train. (As used herein, a train control system is a system that controls movement of the train, such as by activating or deactivating propulsion and braking systems. The train control system can be of both the active type, in which the train control system is primarily responsible for controlling the train's propulsion and/or braking systems for movement of the train, and the passive type, in which a human being is primarily responsible for controlling the train's propulsion and braking systems and the train control system acts only when the train is or is about to be moved in an unsafe manner due to the commands being sent to the propulsion and/or braking system by the human being.) In some embodiments of the invention, the first and second GPS receivers 120, 130 are made by the same manufacturer and include the same GPS chipsets. In other embodiments, the GPS receivers 120, 130 are manufactured by different manufacturers and include different GPS chipsets.

Preferably, the first GPS receiver 120 is mounted at or near the front of a lead locomotive on the train and the second GPS receiver 130 is mounted at or near the rear of the lead locomotive or at the front of the second locomotive. Mounting the first and second GPS receivers 120, 130 at opposite ends of a single locomotive is advantageous because the distance between them will remain fixed. If the two GPS receivers 120, 130 are mounted on different train vehicles (train vehicles is used herein to refer to both locomotives and non-powered wheeled vehicles forming part of a train) on a train, the distance between them will change somewhat due to “slack” between the cars. “Slack” refers to relative movement between two cars provided by the couplings that connect the two train vehicles. A typical coupling allows approximately one foot of relative movement between two train vehicles that are coupled to each other. It is therefore preferable to minimize the number of train vehicles that separate the two GPS receives 120, 130 if they are not mounted on opposite ends of the same train vehicle to ensure that the relative movement between the two train vehicles due to slack does not exceed the accuracy of the GPS receivers. For example, if each GPS receiver is accurate to within 10 meters, the difference between the positions reported by the two receivers at any one time may vary by as much as 20 meters. If two such receivers were separated by 100 vehicles on a train, the relative separation between the two receivers may vary by as much as 100 feet due to slack. This relative movement is much larger than the expected error of the two receivers and is undesirable because it makes it difficult, if not impossible, to determine whether a change in the relative difference in the positions reported by the receivers is due to a GPS error or slack.

Although two GPS receivers 120, 130 are illustrated in FIG. 1, it should be understood that some of the techniques discussed in further detail below require only a single GPS receiver and that some embodiments of the invention that practice such techniques only include a single GPS receiver.

The processor 110 is also connected to a track database 140 (in other embodiments of the invention, the track database 140 will be replaced by a database of other information, such as database that includes information about roads or waterways as appropriate). The track database 140 preferably includes a non-volatile memory such as a hard disk, flash memory, CD-ROM or other storage device, on which track data is stored. Other types of memory, including volatile memory, may also be used. In preferred embodiments, the track data comprises coordinates for a plurality of points corresponding to different locations on the track in a manner well known in the art. The points are not necessarily uniformly spaced. In some embodiments, the points are more closely spaced where the track is curved and less closely spaced where the track is straight. The route or fixed path between points can be described as a vector. In some embodiments, the track data also includes positions of wayside devices such as switches and other points of interest such as grade crossings, stations, etc. The track database 140 also includes information concerning the direction and grade of the track in some embodiments. The track database 140 further includes information as to the route that the train is supposed to follow in some embodiments (in other embodiments, the route information is stored in a separate memory associated with the processor 110, not shown in FIG. 1).

Also connected to the processor 110 is an output device 150. The output device 150 may take various forms. In some embodiments, the output device 150 is a display on which GPS information and/or an indication as to its correctness is displayed. In other embodiments, the output device 150 may be a communication link (such as an RS-232C interface) through which the processor reports GPS position and/or an indication of its correctness to some other system such as a train control system. Those of skill in the art will recognize that, in embodiments in which the processor 110 also functions as a train control computer, the indication may be used internally by the processor 110 to control movement of the train and no output of the GPS information or its correctness is necessary (although such information may be displayed on a monitor or other device in such embodiments).

Various techniques for detecting errors in the GPS positions reported by the GPS receivers 120, 130 will now be discussed in further detail. One, several or all of the various techniques described below are performed in various embodiments. In embodiments that utilize multiple techniques, the multiple techniques may be performed in different orders.

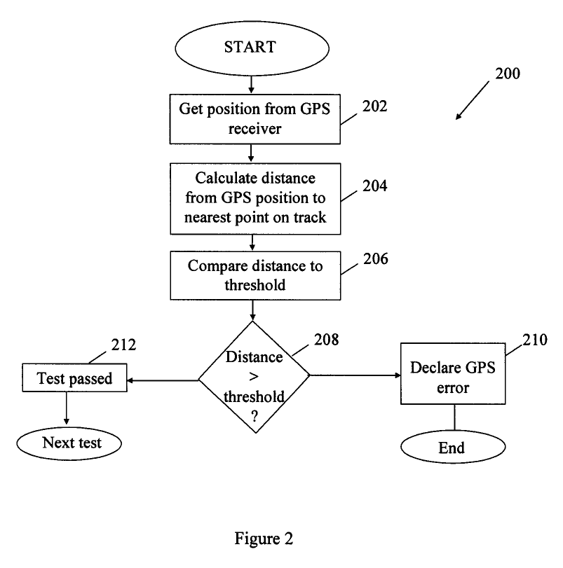

In one embodiment requiring only a single GPS receiver, the processor 110 determines the minimum straight-line distance between the position reported by the GPS receiver and the closest point orthogonal to the track as reflected in the track database. A flowchart 200 illustrating this technique is shown in FIG. 2. A position report is obtained from a GPS receiver at step 202. Next, the straight-line distance between the position reported by the GPS receiver and the nearest orthogonal point on the track is calculated at step 204. The nearest point may be a physical point within the track database or a point residing on a vector between two nearby points. If the distance is less than or equal to the threshold at step 208, the test is declared passed at step 212 and one or more additional checks may then be performed. If the distance is greater than the threshold at step 208, a GPS error is declared at step 210 and the process ends.

For vehicle navigation, the action taken when a GPS error is declared varies. In some embodiments, GPS position report is simply discarded. In other embodiments, other information from an alternate source (such as an axle drive) is used. In yet other embodiments, a penalty brake application may be instituted to stop the train. Those of skill in the art will recognize that other actions are also possible.

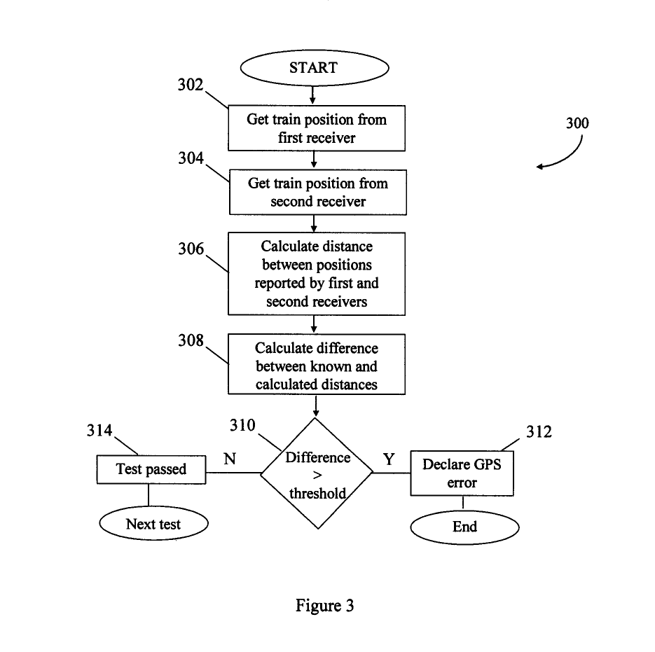

In a second embodiment utilizing two GPS receivers, the processor 110 calculates the difference in the positions reported by the two GPS receivers 120, 130 and compares this difference to the known distance to detect errors in the positions reported by the GPS receivers. (Those of skill in the art will understand that there is some uncertainty in the ‘known’ distance in embodiments in which the two GPS receivers 120, 130 are mounted in different vehicles of the train due to slack as discussed above. In such embodiments, the total slack may be added to the threshold discussed below.) A flowchart 300 of this technique is illustrated in FIG. 3. The processor 110 obtains a position report from the first GPS receiver 120 at step 302 and obtains a position report from the second GPS receiver 130 at step 304. As discussed above, the GPS receivers 120, 130 may be mounted at opposite ends of a single locomotive or other train car, or may be mounted on separate train cars. These difference between the positions reported by the first and second receivers is calculated at step 306. Those of skill in the art will recognize that it will be necessary to compensate the difference in the positions reported by the GPS receivers if the times associated with the position reports are not equal and the train is moving. One way in which to compensate for differences in time between the position reports is to use a speed reported by an axle drive tachometer and the track database to “move” one of the position reports along a heading corresponding to the nearest section of the track by a distance equal to the difference in time between the reports multiplied by the speed reported by the axle drive tachometer. Many other compensation schemes are similarly available.

The difference in the calculated distance between the positions reported by the GPS receivers 120, 130 and the known distance between the GPS receivers is calculated at step 308. This difference is compared to a threshold at step 310. The threshold is based on the stated accuracies of the two receivers. In some embodiments, the threshold is simply the sum of the stated accuracies for the two receivers. In other embodiments, the threshold includes an additional amount related to the accuracy to which the known distance can be determined (e.g., on a train, the difference in distance between adjacent cars can change due to slack as the train accelerates and decelerates). If the difference between the known and calculated distances is greater than the threshold at step 310, a GPS error is declared at step 320. If the difference is less than or equal to the threshold at step 310, this test is declared passed at step 314. One or more additional techniques described below may be performed next.

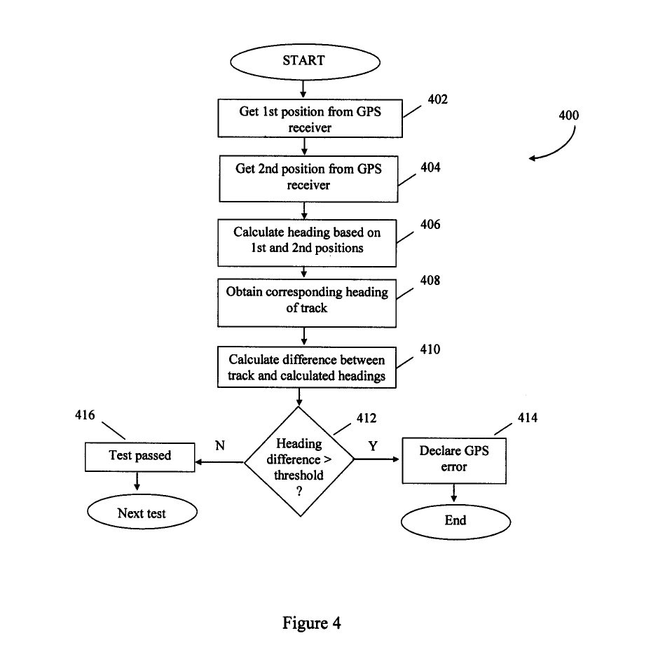

A third technique for detecting errors in GPS position reports is illustrated in the flowchart 400 of FIG. 4. In this technique, a heading based on the position reports from two GPS receivers, or from a single GPS receiver at different points in time, is calculated and compared to the heading of the track as reflected by the track database. A first GPS position is obtained at step 402 and a second GPS position is obtained at step 404. In some embodiments, the first and second positions are taken simultaneously from the first and second GPS receivers 120, 130. In other embodiments, especially those that employ only a single GPS receiver, the first and second positions may be obtained from the same GPS receiver at different times when the train is moving. In the latter case, the times may be chosen such that distance between the first and second GPS positions is approximately equal to the length of the train. However, those of ordinary skill in the art will recognize that shorter or longer distances between the first and second GPS positions are also possible.

Next, the heading is calculated using the first and second GPS positions at step 406. The heading of a corresponding section of track is then obtained at step 408. In some embodiments, the track database 140 stores the track heading for each point in the track database. In other embodiments, the heading is not stored in the track database but rather is calculated using two points from the track database. These two points may be the closest point that has been passed by the train on its current trip and the closest point that has not yet been passed by the train, or may be the two closest points in the track database to the most recent position obtained from a GPS receiver.

The difference between the track heading and the heading calculated using the positions from the GPS receiver(s) is then calculated at step 410. This difference is compared to a threshold at step 412. The threshold takes into account the stated accuracies of the GPS receivers and, preferably, the distance between the two points used to calculate the GPS receiver heading. If the difference between the GPS receiver heading and the track heading is greater than the threshold at step 412, a GPS error is declared at step 414 and the process ends. If the difference between the headings does not exceed the threshold at step 412, then the test is declared passed at step 416.

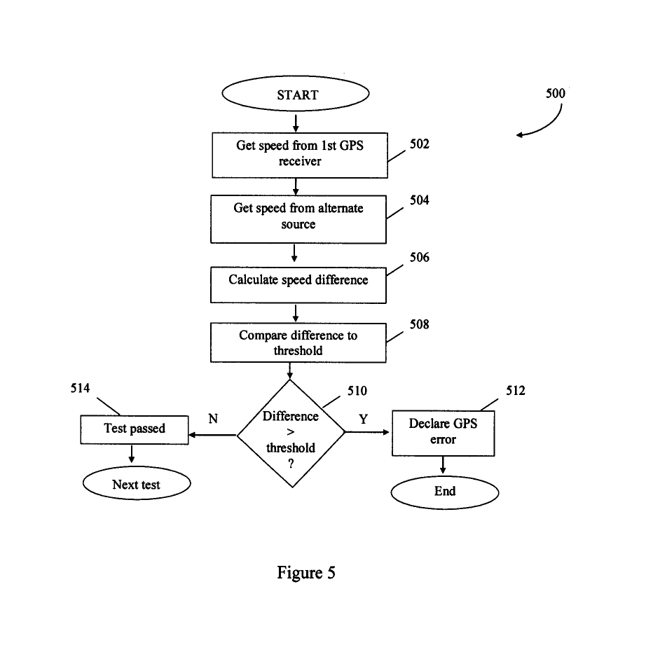

A fourth technique for detecting GPS receiver errors in those embodiments utilizing GPS receivers that provide speed is illustrated in the flowchart of FIG. 5. The speed from the GPS receiver is obtained at step 502. A speed from an alternate source is obtained at step 504. The alternate source is preferably a wheel tachometer, but may be any suitable source as discussed above. The speed reported by the tachometer is preferably compensated for wear of the wheel using one or more of the techniques disclosed in U.S. Pat. No. 6,721,228 or 6,970,774, or co-pending U.S. patent application Ser. No. 10/609,377. The contents of each of the foregoing patents and patent applications are hereby incorporated by reference herein. In some embodiments for use with locomotives having traction motors, a speed may be approximated using the voltage across the traction motor. The difference in the speeds indicated by the GPS receiver and the alternate source is calculated at step 506. This difference is compared to a threshold at step 510. The threshold is based on the stated accuracies of the GPS receiver and the alternate source. If the difference in speeds does not exceed the threshold at step 510, then the test is declared passed at step 514 and the next test (if any) is performed. If the difference in speeds exceeds the threshold, a GPS error is declared at step 512 in embodiments wherein the alternate speed source is deemed more reliable than the GPS receiver. Those of skill will also recognize that other actions are also possible. For example, in embodiments in which the alternate source is not reliable, and where one or more other techniques discussed above have indicated that there is no GPS receiver error, an error in the alternate source rather than the GPS receiver may be declared.

A fifth technique for detecting locomotive position errors that may be caused by GPS involves the use of a radio mounted onboard the train to measure bit timing or carrier phase. The onboard radio (not shown in FIG. 1) may be a transmitter, a receiver, or a transceiver (the term “radio” shall be used generically herein to refer to all three). The onboard radio is configured to communicate with another radio which is preferably stationary and preferably located along the wayside. In some preferred embodiments, the onboard radio is configured for 802.11 standard communications.

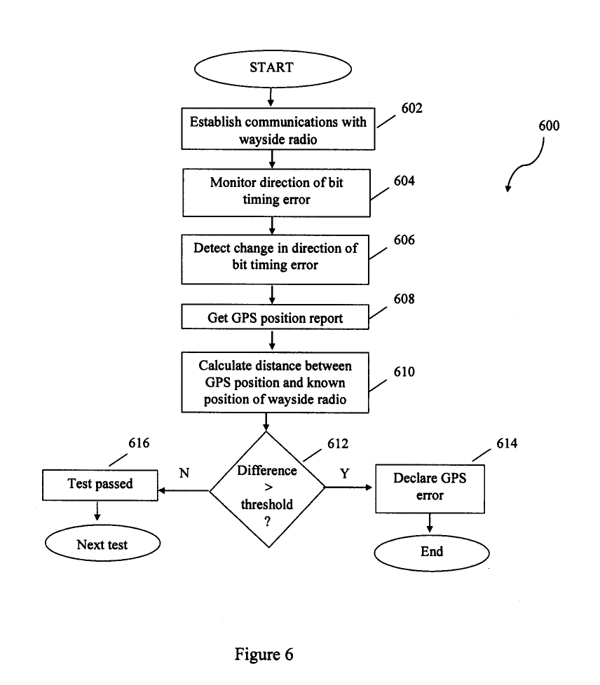

A flowchart 600 illustrating one technique for using radios configured to detect errors in GPS position reports is illustrated in FIG. 6. Communications are established between the onboard radio and a stationary wayside radio at a known location at step 602. The onboard radio monitors the direction of a bit timing error at step 604. The onboard radio detects a change in the direction of the bit timing error at step 606. The direction of bit timing error will change as the train passes the stationary wayside radio. As soon as the direction changes at step 606, the processor 110 obtains a position report from the GPS receiver 120 at step 608 (alternatively, those of skill in the art will recognize that periodic GPS position reports may be obtained and the GPS position corresponding to the moment in time when the direction of the bit error changed may be interpolated using these periodic reports). The difference between the known position of the wayside radio and the GPS position corresponding to the change in the direction of the bit error is calculated at step 610. This distance is then compared to a threshold at step 612. The threshold is based at least in part on the stated accuracy of the GPS receiver. If the distance exceeds the threshold at step 612, a GPS error is declared at step 614. If the distance does not exceed the threshold at step 612, the test is passed at step 616 and the next test is performed.

In some embodiments, the detection of the change in direction of the bit error is used to trigger a reset of the internal odometers (integrators) associated with an axle drive system to a position of the stationary wayside radio. This improves the accuracy of the axle drive system, which may be used in the event that GPS position reports are not available or are erroneous.

The aforementioned technique requires the onboard radio to calculate a direction of bit timing errors. Those of skill in the art will also recognize that the detection of a change in direction of carrier phase shift (i.e., a Doppler shift) may be detected in alternative embodiments. Moreover, the detection in change of bit error direction or carrier phase shift may be detected by the wayside radio rather than the onboard radio. In such embodiments, the wayside radio (which must be a transceiver or a transmitter) signals the onboard radio to alert it of the change, preferably along with a time at which the change was detected so that the processor 110 may determine a corresponding GPS position.

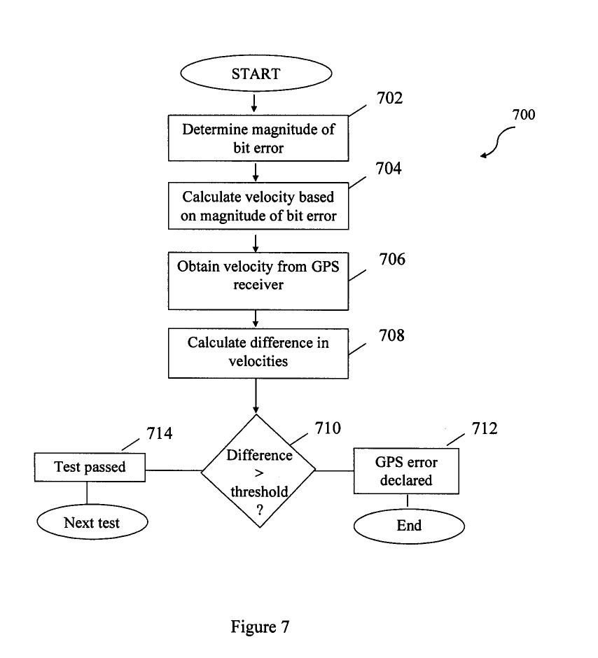

Another technique for using radios to detect errors in GPS positions is illustrated in the flowchart 700 of FIG. 7. In this embodiment, the onboard radio is configured to measure a magnitude as well as a direction of the bit error (or, alternatively, the carrier phase shift). The magnitude of the bit error is indicative of the relative velocity between the onboard radio and the stationary radio. The magnitude of the bit error is calculated at step 702. The velocity is calculated using the magnitude of the bit error at step 704. The velocity is obtained from the GPS receiver 120 at step 706. In some embodiments, the velocity will be provided directly by the GPS receiver 120. In other embodiments, the velocity must be calculated by the processor 110 based on a plurality of position reports from the GPS receiver 120. The processor 110 then determines the difference between the GPS velocity and the velocity calculated using the magnitude of the bit error at step 708. If the difference is greater than a threshold (again based on the stated accuracy of the GPS receiver) at step 710, a GPS error is declared at step 712 and the test ends. If the difference is less than the threshold at step 710, the test is passed at step 714 and the next test is performed.

Yet another technique for detecting errors in GPS receivers involves correlating the vehicle's position with a known location. For example, in the context of a train control system, some embodiments include one or more wayside devices equipped with a device that detects the presence of a train for correlation purposes. In preferred embodiments of train control systems in which the wayside devices include transceivers for transmitting train control signals (such as track warrants, authorizations, or signal aspects), the wayside devices may include a detection device such as a hot bearing detector, magnetic pickup or other device. When the vehicle in which the GPS receiver is mounted (preferably the lead locomotive in the train) passes the detection device, the wayside device transmits a message to the train control system indicating the time at which the detection occurred. This time is used to correlate the position reported by the GPS receiver at a corresponding time.

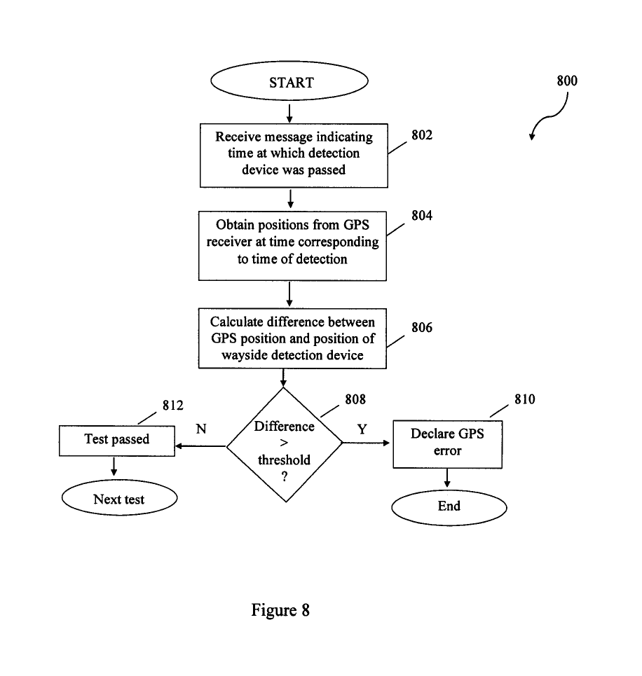

A flowchart 800 illustrating the processing performed by onboard equipment (e.g., a train control system) employing such a technique is illustrated in FIG. 8. The processor 110 receives at step 802 a message via a transceiver (not shown in FIG. 1) from a wayside device including a time at which the vehicle in which the GPS receiver 120 is mounted passed the detection device. A position from the GPS receiver 120 at a corresponding time is obtained at step 804. As discussed above, if there is not a GPS position report corresponding to the exact time indicated in the message from the wayside device, the position reported by the GPS receiver is corrected based on the speed and heading of the train (or the direction of the track) and the difference in times. The difference between the GPS position and the position of the wayside detection device is calculated at step 806. The position of the wayside detection device may be stored in a database onboard the train vehicle or may be included in the message sent by the wayside device. The message from the wayside device includes an identifier of the wayside device in some embodiments. This difference is compared to a threshold (again based at least in part on the stated accuracy of the GPS receiver) at step 808. If the difference exceeds the threshold at step 808, a GPS error is declared at step 810 and corrective action is taken. If the difference does not exceed the threshold at step 808, the test is passed at step 812 and the next test is then performed.

Still another technique for improving the accuracy of GPS receivers involves using a GPS receiver (A) at a fixed location on the wayside as a differential GPS base station. A differential GPS base station receives data from the available satellite constellation and checks the health of individual satellites and determines any individual corrections needed. Comparing the navigation solution position to a surveyed position, the differential base station generates a correction message that informs other GPS receivers as to corrections needed for use in specific satellites.

A second GPS receiver (B), optimally a different make/model, takes the correction information and applies it to the generation of its navigation position solution. It then compares the navigation position prediction with the known surveyed location in an effort to validate the corrections to be sent to the train or other remote mobile systems.

It is important to note the following:
(a) The exact latitude and longitude of the primary base location may have some endemic error from the recorded “surveyed” location and the predominant GPS average location. If true, the error will be consistent and may be compensated mathematically. Also, the error can be ignored if the base location was the primary reference for the system coordinates including the track database or maps.
(b) Once the validation of the corrections commences, the correction data must be protected via CRC32 or another process which yields a six sigma confidence upon the detection of corruption. Because of the insecurity of typical serial data, the corrections should be introduced into the secondary GPS receiver (B) and multiplicity of times.

Once the corrections have been verified, by an error comparison with the secondary GPS receiver (B), the corrections may be transmitted to the trains or other mobile systems via a plurality of methods. CRC32 or equivalent is used by the recipient for transmission validation.

The train or other mobile system optimally will use two GPS receivers, ideally one at or near the front of the locomotive and one at or near the rear. This will provide additional data input at a later stage. The primary GPS receiver (C) on the train or other mobile system ideally should be the same make/model as the validation receiver (B). It should also introduce the corrections a multiplicity of times. The second (fourth) GPS receiver (D) on the train or other mobile system ideally should be a different make/model from the primary mobile GPS receiver (C). This receiver (D) should also have the corrections introduced a multiplicity of times.

Statistically the system inspects the probabilities that the two receivers on the mobile system, with the corresponding HDOP (or PDOP, etc.) are at an appropriate relative position with respect to each other (the distance from C to D), the probabilities that the two receivers are within certain error allowances of the on-board track map (database), and the relative heading between the two receivers agrees with the apparent heading described within the track database. Optionally the individual headings of the two receivers can be compared to the track database once the vehicle is in motion.

With respect to the measurement of the distance between receivers (C) and (D), the relative differential GPS system applies (i.e., the difference between the positions reported by the two receivers can be used without differential GPS connections for the reasons discussed in U.S. Pat. No. 7,142,982). Actual differential GPS is not required, but is used optimally to compensate for satellite vehicle errors, selective availability (currently off), or any other error that would impact both receivers simultaneously and therefore not be corrected and would therefore adversely impact the actual global position calculation for the physical vehicle location.

All of these factors combine to determine an error radius ‘R’ that is commensurate with the needed six sigma confidence. As the statistical confidence grows, the needed error distance decreases.

The statistical confidence gained by inspection of the relative heading is a function of the installed distance between the two receivers (C) and (D). The greater the distance between the receivers, the greater the statistical increase in confidence.

The statistical confidence in the receivers being co-located with the map contained with the onboard track database increases as the overall error radius increases. Said another way, as the error radius increases, if the receivers are reporting locations on the actual track map, the confidence in the accuracy of the position fix increases.

Tables 1 and 2 set forth the six sigma accuracies of the GPS system with various combinations of the embodiments discussed above at various HDOP values. Table 1 lists the six sigma accuracies with Selective Availability turned off while Table 2 lists the accuracies with selective availability turned on. “Single GPS” in Tables 1 and 2 refers to a system with a single GPS receiver operated without the benefit of any of the techniques discussed above. “Single GPS w/Map” refers to a single GPS receiver combined with the map cross checking technique discussed above in connection with FIG. 2. “Single GPS w/Map & Heading” refers to a single GPS receiver combined with the map cross-checking technique of FIG. 2 and the heading checking technique of FIG. 4. “Dual GPS” refers to a train with two GPS receivers mounted at the front and rear, respectively, of the lead locomotive or other vehicle on the train combined with the distance checking technique of FIG. 3. “Dual GPS w/Map” refers to a train with two GPS receivers as described in the previous sentence operated in accordance with the techniques of FIGS. 2 and 3. Finally, “Dual GPS w/Map & Heading” refers to a train with two GPS receivers as described above operated in accordance with the techniques of FIGS. 2, 3 and 4. It should again be noted that achieving six sigma reliability required more than a single position sample due to the internal mathematics employed by the GPS receivers.

TABLE 1
Six Sigma Differential GPS - Distance in Meters

| | | | | Single GPS | | |
|---|---|---|---|---|---|---|
| | Dual GPS | | | w/ Map & | | |
| | w/ Map & | Dual GPS | | Heading | Single GPS | |
| HDOP | Heading | w/ Map | Dual GPS | (1) | w/ Map | Single GPS |
| 1 | 7.09 | 12.3 | 13.6 | 15.4 | 18.7 | 19.8 |
| 2 | 12.3 | 23.5 | 27.3 | 30.0 | 36.5 | 39.6 |
| 3 | 16.9 | 34.1 | 40.9 | 44.2 | 54.1 | 59.4 |
| 4 | 20.8 | 44.5 | 54.5 | 58.1 | 71.5 | 79.2 |
| 5 | 24.3 | 54.6 | 68.2 | 71.8 | 88.7 | 99 |

TABLE 2
Six Sigma Non-Differential GPS - Distance in Meters (No SA)

| | | | | Single GPS | | |
|---|---|---|---|---|---|---|
| | Dual GPS | | | w/ Map & | | |
| | w/ Map & | Dual GPS | | Heading | Single GPS | |
| HDOP | Heading | w/ Map | Dual GPS | (1) | w/ Map | Single GPS |
| 1 | 14.4 | 28.0 | 33.0 | 36.0 | 44.0 | 48 |
| 2 | 23.8 | 53.1 | 66.1 | 69.7 | 86.1 | 96 |
| 3 | 31.1 | 76.9 | 99.2 | 102.5 | 127.4 | 144 |
| 4 | 37.0 | 99.9 | 132.3 | 134.6 | 168.2 | 192 |
| 5 | 41.9 | 122.2 | 165.3 | 166.2 | 208.6 | 240 |

Combining the techniques of FIGS. 2, 3, and 4 with two GPS receivers mounted at or near the front and rear of a train vehicle, combined with the use of CRC-32 communication yields a GPS system whose operation can be said to be failsafe or vital. It has a six sigma confidence with respect to position and error, it is redundant and self-checking, and it also compensates for serial communications errors, and can detect satellite vehicle errors.

The user may decide to remove the differential base station and use stand-alone GPS. In this case, the precision is limited by the GPS atmospherics, Selective Availability, and other means. But using the dual receivers on the mobile equipment allows for the diversity and self-checking needed to compensate for serial and GPS receiver errors. In this case, the error radius grows due to the inclusion of systemic inaccuracies. The accuracies are understood, categorized, and measured.

The penalty for not using the differential system and using only the dual receiver system is on the order of an additional 8 to 20 meters of uncertainty with Selective Availability turned off. This is because the use of the relative differential technique eliminates common mode errors shared by the base and mobile system such as errors due to atmospherics. This value varies with the HDOP. The full system (a system with two stationary receivers off the train and two receivers on the locomotive employing the heading and map techniques discussed above has the ability to reduce the six sigma uncertainty in standard GPS (not including serial communication errors, single receiver non-vital design features, etc.) from 240 meters to 24 and from 48 meters to 7. Again, the values vary with HDOP.

Various embodiments of methods and systems for detecting errors in GPS receivers have been discussed above. It should be understood that the detailed description set forth above is not intended to limit the present invention and that numerous modifications and changes to the specific embodiments set forth above can be made without departing from the spirit and scope of the invention. Rather, the present invention is only limited by the following claims.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. A method for making the derived position from a global positioning system (GPS) receiver mounted onboard a train or other vehicle, vital, the method comprising the steps of:
receiving GPS data from a plurality of satellites at a first GPS receiver located off the train, the first GPS receiver being at a first known position;
determining any corrections necessary for each of the plurality of satellites by comparing the positions reported by the satellites to the first known position;
receiving additional GPS data at a second GPS receiver located off the train, the second GPS receiver being at a second known location which may be the same or different from the first known location;
validating the corrections calculated using the GPS data from the first GPS receiver using the additional GPS data from the second GPS receiver;
if the corrections are valid, transmitting a message including the corrections to the train; and
using the corrections and GPS data from a third GPS receiver to determine the position of the train.

2. The method of claim 1, further comprising the step of appending a checksum to the message, the checksum being sufficient to provide a six sigma degree of confidence that the data in the message has not been corrupted due to transmission errors.

3. The method of claim 2, wherein the checksum is a CRC-32 checksum.

4. The method of claim 1, further comprising the steps of:
obtaining a first train position from the third GPS receiver;
obtaining a second train position from a fourth GPS receiver, the fourth GPS receiver being located on the train and being separated from the third GPS receiver by a known distance;
calculating a GPS distance between the first train position and the second train position;
comparing the GPS distance to the known distance; and
taking corrective action if a difference between the GPS distance and the known distance exceeds a threshold.

5. The method of claim 4, wherein the third and fourth GPS receivers are mounted in a same vehicle of the train and the known distance is fixed.

6. The method of claim 5, wherein the first train position and the second train position are obtained at different times and at least one of the first train position and the second train position are compensated for the time difference.

7. The method of claim 1, further comprising the steps of:
obtaining a first train position from the third GPS receiver;
obtaining a second train position from the third GPS receiver;
calculating a GPS heading based on the first and second train positions;
comparing the GPS heading to a corresponding track direction, the corresponding track direction being obtained from a track database stored on the train; and
taking corrective action if a difference between the GPS heading and the corresponding heading from the track database exceeds a threshold.

8. The method of claim 1, further comprising the steps of:
obtaining a GPS position from the third GPS receiver;
calculating a distance between the GPS position and a nearest point corresponding to a track on which the train is traveling;
comparing the distance to a threshold, the threshold being based at least in part on an accuracy of the third GPS receiver; and
taking corrective action if the distance is greater than the threshold.

9. The method of claim 8, wherein the distance between the nearest point on the track on which the train is traveling and the GPS position is determined by selecting two points that are closest to the GPS position from a track database that stores a plurality of points corresponding to the track, and determining a shortest distance between the GPS position and a line formed between the two points.

10. The method of claim 8, wherein the distance between the nearest point on the track on which the train is traveling and the GPS position is determined by obtaining a first point corresponding to a nearest point in a track database that the train has passed on its current trip in its current direction, the track database storing a plurality of points corresponding to the track, obtaining a second point corresponding to a nearest point in the track database that the train has not passed on its current trip in its current direction, and calculating a shortest distance between the GPS position and a line formed between the first and second points.

11. The method of claim 1, further comprising the steps of:
determining a dilution of precision (DOP);
determining a six sigma safety distance based at least in part on the DOP; and
using the six sigma safety distance to determine when the train must be stopped.

12. The method of claim 11, wherein the DOP is a horizontal DOP.

13. A train control system comprising:
a first GPS receiver located off the train, the first GPS receiver being at a first known position;
a second GPS receiver located off the train, the second GPS receiver being at a second known position;
a third GPS receiver mounted on the train;
a first processor in communication with the first and second GPS receivers, the first processor being configured to perform the steps of
determining any corrections necessary for GPS data received from each of a plurality of satellites at the first GPS receiver by comparing the positions reported by the satellites to the first known position;
validating the corrections in the correction message at the second GPS receiver;
if the corrections are valid, transmitting a message including the corrections to train;
a second processor in communication with the third GPS receiver; the second processor being configured to perform the steps of
using the corrections and position information from the third GPS receiver to determine the position of the train.

14. The system of claim 13, wherein the first processor is further configured to perform the step of appending a checksum to the message, the checksum being sufficient to provide a six sigma degree of confidence that the data in the message has not been corrupted due to transmission errors.

15. The system of claim 14, wherein the checksum is a CRC-32 checksum.

16. The system of claim 13, wherein the second processor is further configured to perform the steps of:
obtaining a first train position from the third GPS receiver;
obtaining a second train position from a fourth GPS receiver, the fourth GPS receiver being located on the train and being separated from the third GPS receiver by a known distance;
calculating a GPS distance between the first train position and the second train position;
comparing the GPS distance to the known distance; and
taking corrective action if a difference between the GPS distance and the known distance exceeds a threshold.

17. The system of claim 16, wherein the third and fourth GPS receivers are mounted in a same vehicle of the train and the known distance is fixed.

18. The system of claim 17, wherein the first train position and the second train position are obtained at different times and at least one of the first train position and the second train position are compensated for the time difference.

19. The system of claim 13, wherein the second processor is further configured to perform the steps of:
obtaining a first train position from the third GPS receiver;
obtaining a second train position from the third GPS receiver;
calculating a GPS heading based on the first and second train positions;
comparing the GPS heading to a corresponding track direction, the corresponding track direction being obtained from a track database stored on the train; and
taking corrective action if a difference between the GPS heading and the corresponding heading from the track database exceeds a threshold.

20. The system of claim 13, wherein the processor is further configured to perform the steps of:
obtaining a GPS position from the third GPS receiver;
calculating a distance between the GPS position and a nearest point corresponding to a track on which the train is traveling;
comparing the distance to a threshold, the threshold being based at least in part on an accuracy of the third GPS receiver; and
taking corrective action if the distance is greater than the threshold.

21. The system of claim 20, wherein the distance between the nearest point on the track on which the train is traveling and the GPS position is determined by selecting two points that are closest to the GPS position from a track database that stores a plurality of points corresponding to the track, and determining a shortest distance between the GPS position and a line formed between the two points.

22. The system of claim 20, wherein the distance between the nearest point on the track on which the train is traveling and the GPS position is determined by obtaining a first point corresponding to a nearest point in a track database that the train has passed on its current trip in its current direction, the track database storing a plurality of points corresponding to the track, obtaining a second point corresponding to a nearest point in the track database that the train has not passed on its current trip in its current direction, and calculating a shortest distance between the GPS position and a line formed between the first and second points.

23. The system of claim 13, wherein the second processor is further configured to perform the steps of:
determining a DOP;
determining a six sigma safety distance based at least in part on the DOP; and
using the six sigma safety distance to determine when the train must be stopped.

24. The system of claim 23, wherein the DOP is a horizontal DOP.
